(19) United States
(12) Patent Application Publication
(10) Pub. No.: US 2005/0247823 A1
(43) Pub. Date: Nov. 10, 2005

(54) Injection-molded polycarbonate door

(76) Inventors: Jeffrey H. Wood, Eureka, MO (US); Terry A. Sewell, Ballwin, MO (US)

Correspondence Address: Michael S. Smith;BLACK LOWE & GRAHAM PLLC, Suite 4800, 701 Fifth Avenue, Seattle, WA, 98104, US

(21) Appl. No.: 10/838,458

(22) Filed: May 4, 2004

(51) Int. Cl. B64C 29/00

(52) U.S. Cl. 244/129.5

(57) ABSTRACT

Door systems and methods of making a door that provide added security in a vehicle, such as a commercial aircraft. An example door system includes a door, a source of pressurized fluid, and a frame. The door includes an injection-molded polycarbonate base, a plurality of hinge inserts embedded within the injection-molded polycarbonate base, and an inflatable seal. The source inflates the inflatable seal. The frame includes hinges that attach to the plurality of hinge inserts.

### FIELD OF THE INVENTION

This invention relates to doors, and, more particularly, to security doors with observation measures.

### BACKGROUND OF THE INVENTION

Recent events have shown a need for additional cockpit security in commercial aircraft. Secured doors that provide for crew safety is a concern for pilots, crew members, and passengers. There is an additional desire by aircraft manufacturers to not add additional weight to an aircraft, such as might occur if the cockpit doors were heavy metal doors. Increased aircraft weight typically results in increased operational costs (e.g. greater fuel consumption).

Therefore, there exists a need to provide security to airplane cockpits without significantly increasing the weight and cost of the airplane, thereby decreasing payload revenue.

### SUMMARY OF THE INVENTION

The present invention provides door systems and methods of making a door that provide added security in a vehicle, such as a commercial aircraft. An example door system includes a door, a source of pressurized fluid (e.g. a pump), and a frame. The door includes an injection-molded polycarbonate base, a plurality of hinge inserts embedded within the injection-molded polycarbonate base, and an inflatable seal. The source of pressurized fluid inflates the inflatable seal. The frame includes hinges that attach to the plurality of hinge inserts.

In one aspect of the invention, the system includes a switch for activating the pneumatic pump. The switch is activated when the door is in a locked position relative to the frame.

In another aspect of the invention, the door includes lock inserts that are embedded within the injection-molded polycarbonate base. The frame includes locking pins that are slideably received by a corresponding one of the locking inserts when the door is in a closed position. A locking device controls the position of the locking pins.

In a further aspect of the invention, the door includes a door handle device having a door handle insert embedded within the injection-molded polycarbonate base, and a door handle that is attached to the door handle insert.

### BRIEF DESCRIPTION OF THE DRAWINGS

The preferred and alternative embodiments of the present invention are described in detail below with reference to the following drawings.

FIG. 1 illustrates a cut-away side elevational view of a cabin door and corresponding systems formed in accordance with embodiment of the present invention;

FIGS. 2 and 3 are perspective views of a cabin door formed in accordance with an embodiment of the present invention;

FIG. 4 illustrates an enlarged side elevational view of a hinge edge of the cabin door illustrated in FIGS. 2 and 3;

FIG. 5 illustrates a side elevational view of door handles and a corresponding edge of the cockpit door of FIGS. 2 and 3; and

FIG. 6 illustrates a top-down cross-sectional view of the components of the cockpit door illustrated in FIGS. 2 and 3 and the bulkheads that attach to the door.

### DETAILED DESCRIPTION

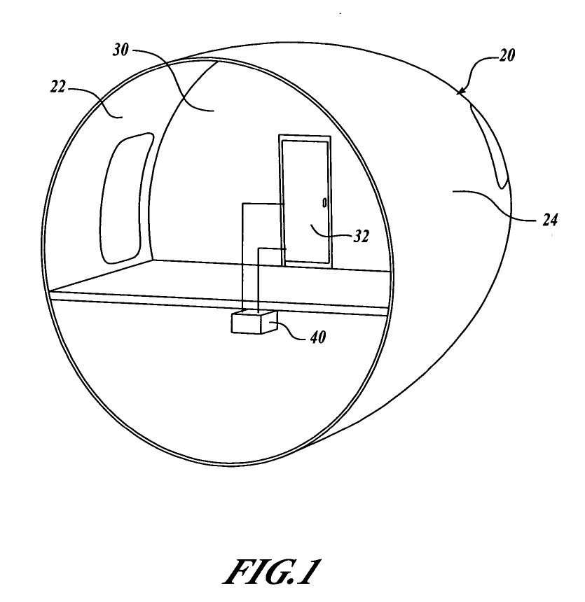

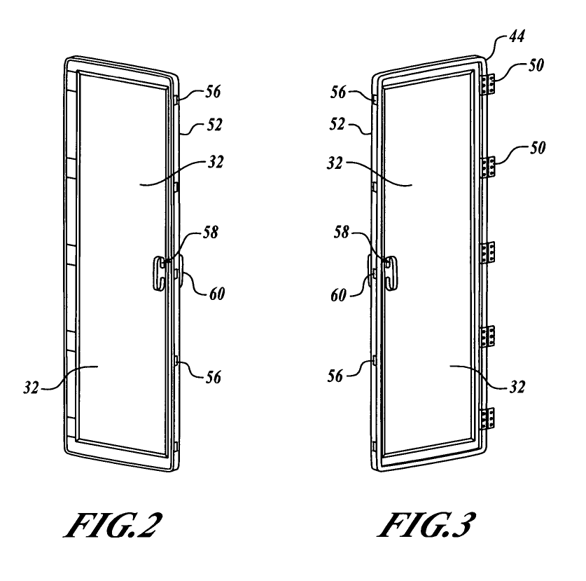

The present invention relates to apparatus and methods for providing a lightweight, secure barrier between an aircraft cockpit and cabin. Many specific details of certain embodiments of the invention are set forth in the following description and in FIGS. 1-6 to provide a thorough understanding of such embodiments. One skilled in the art, however, will understand that the present invention may have additional embodiments, or that the present invention may be practiced without several of the details described in the following description.

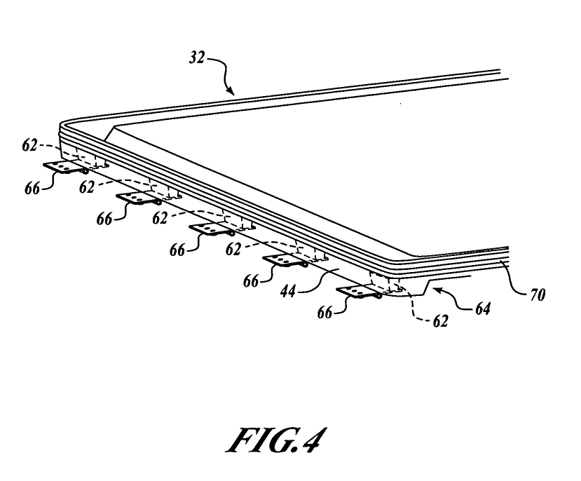

FIG. 1 illustrates a cut-away side elevational view of an aircraft fuselage 20 as viewed towards a cockpit 24 of the aircraft 20. In this embodiment, the cockpit 24 is separated from the cabin 22 by the bulkhead 30 having a door 32. The door 32 is a polycarbonate door (e.g. an injection-molded polycarbonate door) that in one embodiment includes an inflatable seal that is coupled to a source 40 (e.g. a pneumatic pump system, a pressurized vessel, engine bleed air, etc.). In one embodiment, the source 40 is activated by a switch that senses when the door 32 is in a closed position. The door 32 is described by example and more detail below with regard to FIGS. 2-6.

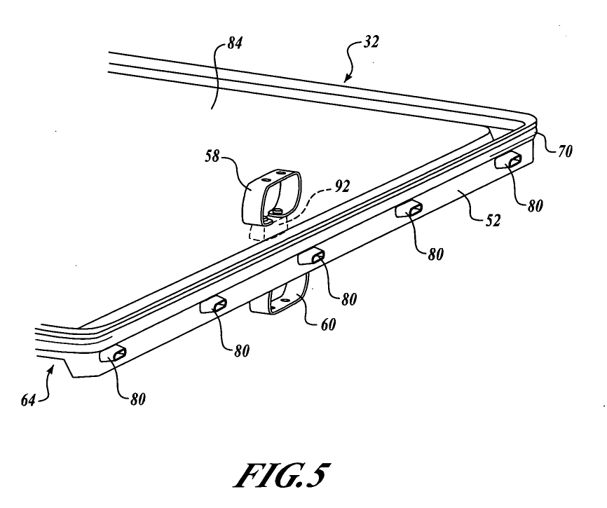

FIGS. 2 and 3 illustrate perspective views of an example of the door 32. The door 32 includes a first edge 44, a second edge 52, and interior and exterior handles 58 and 60. The first edge 44 includes or is attached to a plurality of hinges 50. The second edge 52 includes a plurality of locking devices 56.

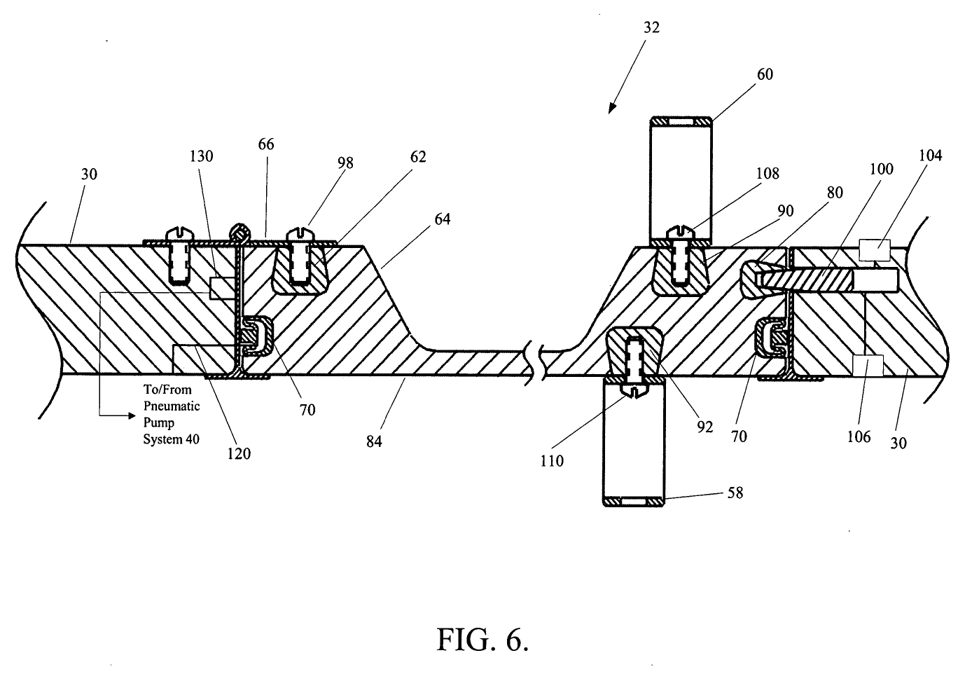

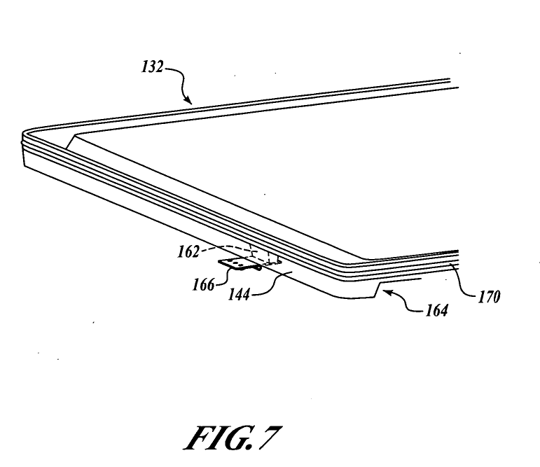

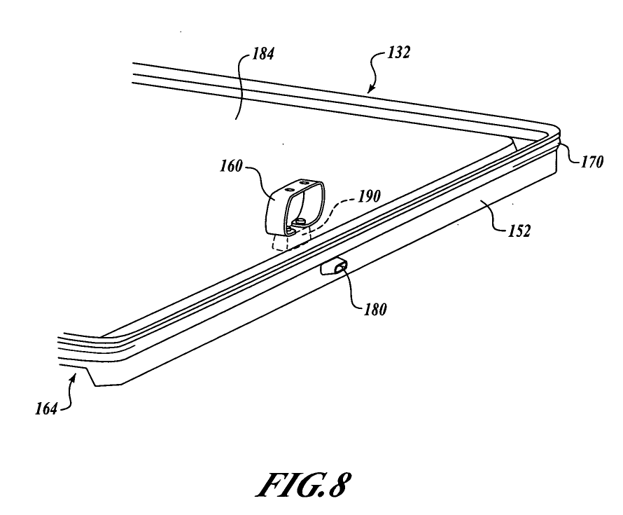

FIG. 4 illustrates an enlarged side elevational view of the first edge 44 of the cockpit door 32. During the molding process of the door 32, hinge inserts 62 are molded into a first side 64 of the door 32 at or near the first edge 44. The hinge inserts 62 are exposed at the surface of the first side 64, but are not removable from the door 32 because the hinge inserts 62 expand in width from the surface of the side 64. A hinge 66 is attached to each of the hinge inserts 62. The hinges 66 and hinge inserts 62 are described in more detail below with regard to FIG. 6.

The outer perimeter of the door 32 (i.e., the first and second edges 44 and 52, a base edge and top edge) includes a groove for receiving an inflatable seal 70. The inflatable seal 70 is pneumatically connected to the source 40 as shown in FIG. 1. In alternate embodiments of the present invention, the inflatable seal 70 may be attached to the bulkhead 30 rather than to the door 32.

FIG. 5 illustrates the cockpit door 32 at the second edge 52. Embedded into the edge 52 are a plurality of lock sockets 80. The lock sockets 80 are similar in shape to the hinge inserts 62 (FIG. 4) and are exposed at the edge 52. Embedded into the first side 64 and a second side 84 of the door 32 are handle inserts 90 and 92, respectively. The handle inserts 90 and 92 are shaped similarly to the lock sockets 80 such that once they are embedded into the door 32, they cannot be removed without destruction of the door 32. The handle-locking sockets 90 and 92 are exposed at the respective side for receiving the corresponding handles 60 and 58, respectively. Attachments of the handles 60 and 58 to the handle inserts 90 and 92 are shown in more detail below with regard to FIG. 6.

FIG. 6 illustrates a top-down cut-away view of the door 32 hingedly attached to the bulkhead 30. Each hinge 66 is attached by a threaded bolt 98 that is received by a threaded cavity formed by the hinge insert 62. The hinges 66 are also fastened to the bulkhead 30 in a conventional manner. Other mechanisms for attaching the hinges 66 to the hinge inserts 62 and to the bulkhead 30 may be used, such as rivets, other fastening mechanisms or adhesives.

As further shown in FIG. 6, each lock socket 80 forms a cavity for receiving a locking pin bayonet 100 that is partially recessed within the bulkhead 30. Each locking pin bayonet 100 may be spring-loaded into a locked position, i.e., a position that would allow it to be received by the cavity formed by the lock socket 80. Each locking pin bayonet 100 may be manually operated or may include an opening device, such as an electromechanical device (e.g. a solenoid actuator). The electromechanical device may be activated by a switch 104 accessible from the cockpit 24 and/or a switch 106 accessible from the cabin 22. The switches 104 and 106 may be coded for more secure access. The locking pin bayonets 100 and the opening device may also be coupled to a switch located elsewhere within the cockpit 24.

The handle inserts 90 and 92 may include threaded cavities for receiving threaded bolts 108 and 110, respectively, that pass through an opening in the handles 60 and 58, thereby affixing the handles 60 and 58 to the respective inserts 90 and 92.

A pneumatic line 120 pneumatically connects the seal 70 with the source 40. In one embodiment, an electromechanical switch 130 produces a signal sensing that the door 32 is in the closed position and sends that signal to the source 40, thereby instructing the source 40 to send pressurized fluid (e.g. air) through the pneumatic line 120 to inflate the seal 70. When the seal 70 is pressurized, it provides an environmental seal between the cockpit 24 and the cabin 22. Other switching mechanisms can be linked to the source for activating the source 40. For example, the switches 104 and 106 can produce signals that indicate when the locking pin bayonets 100 are in a locked position. As previously noted, in alternate embodiments, the seal 70 may be coupled to the bulkhead 30 and disposed about the perimeter of the door 32, and may be inflated using the source 40 in substantially the same manner to provide the desired environmental seal.

The injection-molded polycarbonate door described above may provide significant advantages over prior art door systems. For example, the polycarbonate door may provide the desired degree of strength, yet may be very light weight. The door may also provide ballistic resistance to prevent intrusion by handguns, rifles, or other types of break-in, while being transparent. The transparent feature allows the flight crew visual indication of flight cabin conditions.

Furthermore, the pneumatic seal allows for independent cockpit pressurization in the event of accidental or man-made pressure loss in the cabin. The pneumatic seal allows for an independent air supply to be provided to the cockpit in the event of accidental or man-made disruptions in the cabin breathing air. The seal may also provide air crew separation if the cabin were to be infused with an airborne aerosol sedative for temporarily incapacitating cabin occupants in the event of a security risk.

In one embodiment, the door includes a one way mirror for allowing flight crew to see into the cabin and not allow passengers to view into the cockpit. Alternatively, the door may be coated with a film, such as an electrically charged coating, that when charged makes the door opaque and when uncharged makes the door transparent, including, for example, an electrochromic device of the type generally disclosed in co-pending, commonly-owned U.S. Patent Application No. (undetermined) entitled “Low Vapor Pressure Solvent for Electrochromic Devices”, filed under Attorney Docket No. BING-1-1066 on Mar. 12, 2004, and in co-pending, commonly-owned U.S. Patent Application No. 60/552,589 entitled “Multi-Color Electrochromic Device” filed on Mar. 12, 2004, and in co-pending, commonly-owned U.S. Patent Application No. 60/552,453 entitled “Dimming Window Control Systems and Methods” filed on Mar. 12, 2004, which applications are hereby incorporated by reference.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A method of making a door, comprising:
inserting at least one hinge insert into a mold; and
generating a polycarbonate door in the mold at least partially around the at least one hinge insert.

2. The method of claim 1, further comprising inserting an inflatable seal into a groove around a perimeter of the door.

3. The method of claim 1, further comprising inserting one or more handle inserts into the mold prior to generation of the polycarbonate door.

4. The method of claim 3, wherein at least one of the inserts forms a cavity having an opening and a base opposite the opening, and wherein the circumferential dimension of the insert at the opening is smaller than the circumferential dimension at the base.

5. The method of claim 1, further comprising inserting one or more bolt-locking inserts into the mold prior to the generation of the polycarbonate door.

6. The method of claim 5, wherein at least one of the inserts forms a cavity having an opening and a base opposite the opening and wherein the circumferential dimension of the insert at the opening is smaller than the circumferential dimension at the base.

7. The method of claim 1, wherein generating a polycarbonate door in the mold includes injection molding a polycarbonate door in the mold.

8. The method of claim 1, wherein generating a polycarbonate door in the mold includes generating a substantially transparent polycarbonate door in the mold.

9. A door comprising:
a polycarbonate base; and
at least one hinge insert permanently embedded within the polycarbonate base.

10. The door of claim 9, further comprising at least one external hinge component being connected to one of the at least one hinge inserts and to a cockpit bulkhead of an aircraft.

11. The door of claim 9, further comprising one or more door handle inserts embedded within the polycarbonate base.

12. The door of claim 9, further comprising one or more locking pin inserts embedded within the polycarbonate base.

13. The door of claim 9, further comprising a pneumatic seal embedded within a groove of the polycarbonate base.

14. The door of claim 9, wherein the polycarbonate base comprises an injection-molded polycarbonate base.

15. The door of claim 9, wherein the polycarbonate base comprises a substantially transparent polycarbonate base.

16. The door of claim 9, wherein the polycarbonate base includes a control device for controlling the level of transparency of the polycarbonate base.

17. A door system, comprising:
a door comprising:
a polycarbonate base;
at least one hinge insert permanently embedded within the polycarbonate base; and
an inflatable seal;
a source of pressurize fluid configured to inflate the inflatable seal; and
a frame comprising at least one hinge configured to attach to the at least one hinge insert.

18. The system of claim 17, further comprising a switch for activating the source of pressurized fluid.

19. The system of claim 17, wherein the switch is activated when the door is in a locked position relative to the frame.

20. The system of claim 17, wherein the door further comprises one or more lock inserts embedded within the polycarbonate base.

21. The system of claim 20, wherein the inserts include an opening edge with a circumferential dimension, and a base edge with a circumferential dimension that is smaller than the circumferential dimension of the opening edge.

22. The system of claim 20, wherein the frame further comprises a locking device.

23. The system of claim 22, wherein the locking device comprises:
one or more locking pins configured to be slideably received by a corresponding one of the locking inserts when the door is in a closed position; and
a device for controlling the position of the one or more locking pins.

24. The system of claim 23, wherein the controlling device comprises:
one or more electromechanical devices; and
one or more switches electrically coupled to the one or more electromechanical devices.

25. The system of claim 17, wherein the door further comprises at least one door handle device comprising:
a door handle insert embedded within the polycarbonate base; and
a door handle attached to the door handle insert,
wherein the door handle inserts include a first circumferential dimension around an opening edge and a second circumferential dimension around the base edge, wherein the second circumferential dimension is larger than the first circumferential dimension.

26. An aircraft, comprising:
a door system comprising:
a door comprising:
a polycarbonate base;
at least one hinge insert embedded within the polycarbonate base; and
an inflatable seal;
a source of pressurized fluid configured to inflate the inflatable seal; and
a frame comprising at least one hinge configured to attach to the at least one hinge insert.

27. A method of securing an access opening in a bulkhead between a cockpit and a cabin of an aircraft, comprising:
providing a door operatively coupled to the bulkhead and moveable between an open position allowing passage through the access opening and a closed position preventing passage through the access opening;
providing an inflatable seal disposed around a perimeter of the door, the inflatable seal being disposed at least partially between the door and the bulkhead; and
inflating the inflatable seal.

28. The method of claim 27, wherein providing a door includes providing a polycarbonate door.

29. The method of claim 27, wherein providing a door includes providing a substantially transparent door.

30. The method of claim 27, wherein providing a door includes providing a door that is substantially transparent in a first viewing direction and substantially opaque in a second viewing direction.

31. The method of claim 27, wherein providing a door includes providing an injection-molded polycarbonate door.

32. The method of claim 27, wherein providing an inflatable seal disposed around a perimeter of the door includes providing an inflatable seal at least partially disposed within a groove in the perimeter of the door.

33. The method of claim 27, wherein providing an inflatable seal disposed around a perimeter of the door includes providing an inflatable seal at least partially disposed within a groove in the bulkhead around perimeter of the door.

34. The method of claim 27, wherein inflating the inflatable seal includes pumping air into the inflatable seal using a pump.

35. The method of claim 27, wherein inflating the inflatable seal includes inflating the inflatable seal using a source of pressurized air.

36. The method of claim 27, wherein inflating the inflatable seal includes sensing when the door is in the closed position and automatically inflating the inflatable seal when the door is in the closed position.
